(19) United States
(12) Patent Application Publication
(10) Pub. No.: US 2020/0162528 A1
(43) Pub. Date: May 21, 2020

(54) Controlling Streaming Media Players

(71) Applicant: Bose Corporation, Framingham, MA (US)

(72) Inventors: Gregg Michael Duthaler, Needham, MA (US); Marc N. Gudell, Milford, MA (US)

(21) Appl. No.: 16/191,978

(22) Filed: Nov. 15, 2018

(51) Int. Cl. H04L 29/06; H04N 21/258; G06F 8/38

(52) U.S. Cl. CPC H04L 65/4084; G06F 8/38; H04N 21/25875; H04L 65/604

(57) ABSTRACT

A computer-implemented method, system and instructions. A component associated with a user account management system for a streaming media player is integrated within a host application on a control device. The host application is configured to cause the provision of streaming media content. The user account management system is configured to cause the storage of an association of streaming media content with a preset. The control device comprises a user interface (UI) that comprises a preset access feature and is configured to allow a user to interact with both the host application and the user account management system. An association of streaming media content with a preset access feature is determined, where this association is accomplished by the user via the control device UI. In response, an association of streaming media content with the preset is stored, for example in a cloud-based user account.

### BACKGROUND

This disclosure relates to controlling streaming media players.

Streaming media players, for example streaming music players, allow a user to access and stream content from external sources, for example from Internet radio stations or other Internet-based streaming media service providers. Some streaming music players include functionality for allowing a user to access streaming media, such as presets or favorite channels or stations by, for example, actuating a button or other feature on the streaming music player or on a controller for the streaming music player.

### SUMMARY

All examples and features mentioned below can be combined in any technically possible way.

In one aspect, a computer-implemented method includes integrating, within a host application on a control device, a component associated with a user account management system for a streaming media player, wherein the host application is configured to cause the provision of streaming media content and the user account management system is configured to cause the storage of an association of streaming media content with a preset, and wherein the control device comprises a user interface (UI) that comprises a preset access feature and is configured to allow a user to interact with both the host application and the user account management system, and determining an association, by the user via the control device UI, of streaming media content with a preset access feature and in response causing the storage of an association of streaming media content with the preset.

Examples may include one of the above and/or below features, or any combination thereof. The user account management system may be both cloud-based and user-account based, and the method may further comprise presenting on the UI a login feature for the user's account. The component associated with a user account management system for a streaming media player may comprise a software development kit (SDK). The association of streaming media content that is stored with a preset may comprise a media content identifier. The preset access feature may comprise a software preset button. The method may further comprise determining user interaction with the preset button and in response automatically accessing streaming media content. The host application may be associated with an account based music service that is accessible to a user via a first set of account credentials, and the user account management system may be accessible by the user via a second, different, set of account credentials.

In another aspect, a system includes memory and one or more processors that are configured to integrate, within a host application on a control device, a component associated with a user account management system for a streaming media player, wherein the host application is configured to cause the provision of streaming media content and the user account management system is configured to cause the storage of an association of streaming media content with a preset, and wherein the control device comprises a UI that comprises a preset access feature and is configured to allow a user to interact with both the host application and the user account management system, and determine an association, by the user via the control device UI, of streaming media content with a preset access feature, and in response cause the storage of an association of streaming media content with the preset.

Examples may include one of the above and/or below features, or any combination thereof. The user account management system may be both cloud-based and user-account based, and the processors may be further configured to present on the UI a login feature for the user's account. The component associated with a user account management system for a streaming media player may comprise a SDK. The association of streaming media content that is stored with a preset may comprise a media content identifier. The preset access feature may comprise a software preset button. The processors may be further configured to determine user interaction with the preset button and in response automatically access streaming media content. The host application may be associated with an account based music service that is accessible to a user via a first set of account credentials, and the user account management system may be accessible by the user via a second, different, set of account credentials.

In another aspect, one or more non-transitory machine-readable storage devices may have encoded thereon computer-readable instructions for causing one or more processors to perform operations comprising integrating, within a host application on a control device, a component associated with a user account management system for a streaming media player, wherein the host application is configured to cause the provision of streaming media content and the user account management system is configured to cause the storage of an association of streaming media content with a preset, and wherein the control device comprises a UI that comprises a preset access feature and is configured to allow a user to interact with both the host application and the user account management system, and determining an association, by the user via the control device UI, of streaming media content with a preset access feature and in response causing the storage of an association of streaming media content with the preset.

Examples may include one of the above and/or below features, or any combination thereof. The user account management system may be both cloud-based and user-account based, and the method may further comprise presenting on the UI a login feature for the user's account. The component associated with a user account management system for a streaming media player may comprise a SDK. The association of streaming media content that is stored with a preset may comprise a media content identifier. The preset access feature may comprise a software preset button. The operations may further comprise determining user interaction with the preset button and in response automatically accessing streaming media content. The host application may be associated with an account based music service that is accessible to a user via a first set of account credentials, and the user account management system may be accessible by the user via a second, different, set of account credentials.

In another aspect, a computer-implemented method includes integrating, within a user interface for a host application on a control device, a user interface for a user account management system, wherein the host application is configured to provide streaming media content to a media play device that is configured to play the media content and the user account management system is configured to allow a user to access and play media content on the media play device, and wherein the host application user interface is configured to allow a user to interact with the host application and the user account management system user interface is configured to allow the user to interact with the user account management system, determining the user interaction with the user account management system user interface, and in response to determining the user interaction with the user account management system user interface, accessing the user account management system.

Examples may include one of the above and/or below features, or any combination thereof. The user account management system may be both cloud-based and user account-based, and determining the user interaction with the user account management system user interface may comprise allowing the user to log into the user's account. The method may further comprise in response to determining the user interaction with the user account management system user interface, accessing media content of the host application. The method may further comprise in response to determining the user interaction with the user account management system user interface, associating accessed media content with the user account. Associating accessed media content with the user account may comprise assigning the accessed media content to a preset of the user account management system. The method may further comprise determining user interaction with the preset of the user account management system and in response automatically playing the accessed media content on the media play device. The host application may be associated with an account based music service that is accessible to a user via a first set of account credentials, and the user account management system may be accessible by the user via a second (different) set of account credentials.

In another aspect, a system includes memory, and one or more processors configured to integrate, within a user interface for a host application on a control device, a user interface for a user account management system, wherein the host application is configured to provide streaming media content to a media play device that is configured to play the media content and the user account management system is configured to allow a user to access and play media content on the media play device, and wherein the host application user interface is configured to allow a user to interact with the host application and the user account management system user interface is configured to allow the user to interact with the user account management system, determine the user interaction with the user account management system user interface, and in response to determining the user interaction with the user account management system user interface, access the user account management system.

Examples may include one of the above and/or below features, or any combination thereof. The user account management system may be both cloud-based and user account-based, and determining the user interaction with the user account management system user interface may comprise allowing the user to log into the user's account. The one or more processors may be further configured to, in response to determining the user interaction with the with user account management user interface, access media content of the host application.

Examples may include one of the above and/or below features, or any combination thereof. The one or more processors may be further configured to determine the user interaction with the host application user interface, and, in response, access media content of the host application. The one or more processors may be further configured to, in response to determining the user interaction with the user account management system user interface, associate accessed media content with the user account. Associating accessed media content with the user account may comprise assigning the accessed media content to a preset of the user account management system. The one or more processors may be further configured to determine user interaction with the preset of the user account management system, and in response automatically play the accessed media content on the media play device.

In another aspect, one or more non-transitory machine-readable storage devices have encoded thereon computer-readable instructions for causing one or more processors to perform operations comprising integrating, within a user interface for a host application on a control device, a user interface for a user account management system, wherein the host application is configured to provide streaming media content to a media play device that is configured to play the media content and the user account management system is configured to allow a user to access and play media content on the media play device, and wherein the host application user interface is configured to allow a user to interact with the host application and the user account management system user interface is configured to allow the user to interact with the user account management system, determining the user interaction with the user account management system user interface, and in response to determining the user interaction with the user account management system user interface, accessing the user account management system.

Examples may include one of the above and/or below features, or any combination thereof. The user account management system may be both cloud-based and user account-based, and determining the user interaction with the user account management system user interface may comprise allowing the user to log into the user's account. The one or more processors may be further configured to determine the user interaction with the host application user interface, and, in response, access media content of the host application. The one or more processors may be further configured to, in response to determining the user interaction with the user account management system user interface, associate accessed media content with the user account. Associating accessed media content with the user account management system user account may comprise assigning the accessed media content to a preset of the user account management system. The one or more processors may be further configured to determine user interaction with the preset of the user account management system, and in response automatically play the accessed media content on the media play device.

### BRIEF DESCRIPTION OF THE DRAWINGS

The accompanying drawings are not drawn to scale. In the drawings, each identical or nearly identical component that is illustrated in various figures is represented by a like numeral. For purposes of clarity, not every component may be labeled in every drawing. In the drawings:

FIG. 1A is a perspective view of an exemplary streaming music player.

FIG. 1B is a plan view of the streaming music player of FIG. 1A.

FIG. 1C is a block diagram of the streaming music player of FIG. 1A.

FIG. 2 illustrates a control device for the streaming music player of FIG. 1A.

FIG. 3 is a block diagram of a system that is configured to provide streaming media to, and control of, a streaming media player.

FIG. 4 illustrates an exemplary control device user interface that can be used to interface with and control a streaming media player.

FIG. 5 is a flow chart of an exemplary method for controlling a streaming media player.

FIG. 6 illustrates a computer system that can be used to interface with and control a streaming media player.

### DETAILED DESCRIPTION

Aspects and implementations disclosed herein are not limited to the details of methods, construction, and the arrangement of components set forth in the following description or illustrated in the drawings. Aspects and implementations disclosed herein are capable of being practiced or of being carried out in various ways.

Aspects and implementations disclosed herein are generally directed to systems and methods for controlling streaming media players, including but not limited to streaming music players. Streaming music players are used as exemplary streaming media players, but this disclosure is not limited to music players as media players (e.g., those that are configured to play audio, or audio/video media) are also contemplated. In the present disclosure a software component (e.g., a plug-in) for a host streaming media application (“host app”) allows a user to tag content within the host app and thereby associate the content with the user's media player account. A user account management system associated with the media player maintains a user account that includes references to third-party streaming media content, such as presets, playlists, channels, favorites, recently played, and the like. The user interface (UI) of the device with the host app and the plug-in can be used to tag content and assign the tagged content to the user's media player account.

When the user account management system and/or the streaming media player includes one or more presets, one or more sources of streaming audio, for example, from different playlists or channels, can be assigned to an individual preset. The preset defines tagged/assigned content from the source(s). The assigned preset content is then selected or played when the preset is selected. The terms “stations” and “channels” are used interchangeably herein and encompass Internet radio channels, playlists from Internet streaming services, or other pre-defined locations or access points for accessing streaming music or other streaming media, or other audio or media content, for example, news, sports, weather, etc. Although referred to herein as a “streaming music player,” it is to be understood that the disclosed streaming music player may be utilized to stream audio content other than music. Streamed audio can be played directly by the control device (e.g., a smartphone) or the control device can be used to select content that is played by another device, such as a Bluetooth speaker.

The systems and methods disclosed herein may simplify the assignment of streaming media to presets for streaming music players.

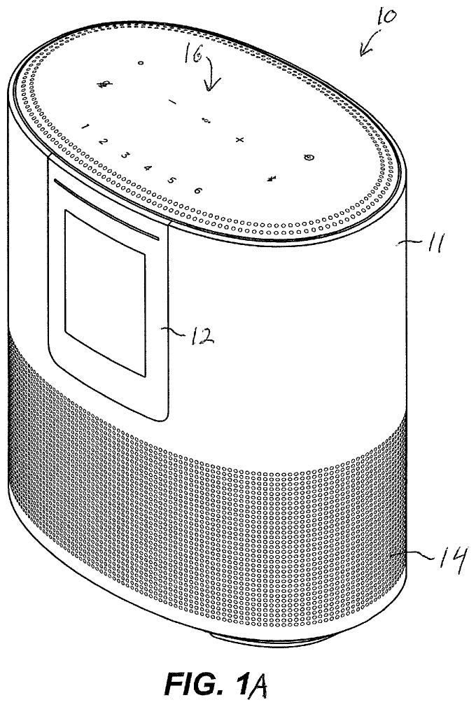

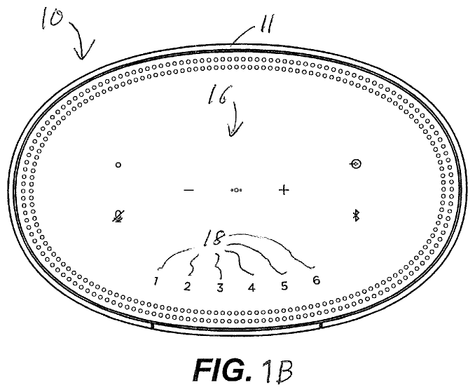

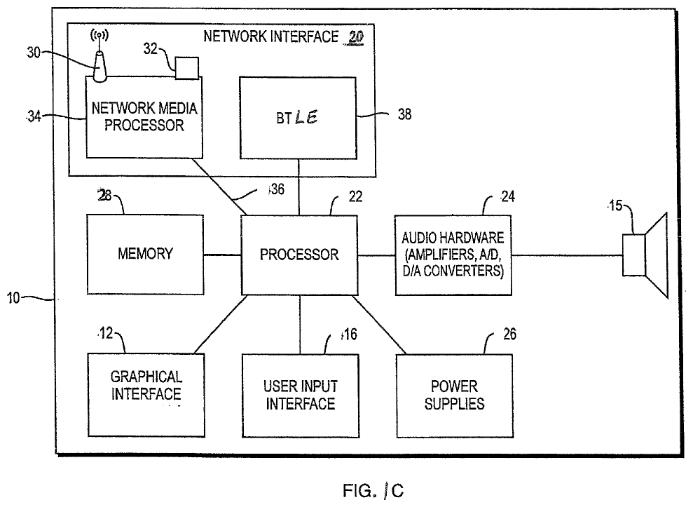

The aspects and implementations disclosed herein are generally applicable to any one of multiple streaming music players. In one particular implementation, the streaming music player is one of the Home Speaker 500 audio playback devices available from the Bose Corporation, Framingham, Mass. U.S.A. An example of such an audio playback device is illustrated in FIGS. 1A-1C. Streaming music players are known in the field, for example as described in co-owned U.S. Pat. No. 9,330,169 “Audio Systems and Related Devices and Methods,” which is incorporated herein by reference in its entirety for all purposes.

Referring to FIG. 1A, audio playback device 10 is an example of a streaming media player device. Device 10 includes an enclosure 11. On enclosure 11 there is found a graphical interface 12 (e.g., an OLED, LCD or other type of display) which can provide a user with information, such as information regarding currently playing (“Now Playing”) music and information regarding the presets. The display can also be used to show a clock, alarm info, weather, or other such information. It can also be used to slowly brighten a room just before an alarm fires, e.g., to help wake a sleeping occupant more gracefully. A grille 14 conceals one or more electro-acoustic transducers 15 (FIG. 1C). Audio playback device 10 also includes a user input interface 16. As shown in FIG. 1B, user input interface 16 comprises user controls, including but not limited to a plurality of preset indicators 18, which are hardware buttons in the illustrated example. Preset indicators 18 (numbered 1-6) provide the user with easy, one-press access to entities assigned to those presets. That is, a single press of a selected one of the preset indicators 18 will initiate streaming and rendering of content from the assigned entity or entities. In some examples, multiple entities may be assigned to the same preset so that the same preset will provide a user with access to media from multiple entities. Assignment of entities to presets, and uses of the presets, is further disclosed in U.S. patent application Ser. No. 15/383,754, filed on Dec. 19, 2016 and published as US 2018/0176274, the entire disclosure of which is incorporated herein by reference for all purposes.

The assigned entities can be associated with different digital audio sources, for example, stations, channels, or playlists from Internet radio stations or streaming music services such as the Pandora®, Spotify®, vTuner®, iHeartRadio®, Deezer®, SiriusXM®, Amazon Music, etc. services. A single audio playback device 10 can provide for single press access to various different digital audio sources. In one example, the assigned entities include at least user-defined playlists of digital music and Internet radio stations. In another example, the digital audio sources include a plurality of Internet radio sites, and the assigned entities include individual radio stations provided by those Internet radio sites.

Notably, the preset indicators 18 operate in the same manner, at least from the user's perspective, regardless of which entities are assigned and which of the digital audio sources provide the assigned entities. That is, each preset indicator 18 can provide for single press access to its assigned entity or entities whether an entity is a user-defined playlist of digital music provided by a network attached storage (NAS) device or an Internet radio station provided by an Internet music service, for example.

With reference to FIG. 1C, the audio playback device 10 also includes a network interface 20, a processor 22, audio hardware 24, power supplies 26 for powering the various audio playback device components, and memory 28. Each of the processor 22, the graphical interface 12, the network interface 20, the audio hardware 24, the power supplies 26, and the memory 28 are interconnected using various busses, and several of the components may be mounted on a common motherboard or in other manners as appropriate.

The network interface 20 provides for communication between the audio playback device 10 and a controller (for example, a remote control, a smart phone, a smart watch, smart eyeglasses, a tablet, or a computer having an appropriate control app installed), a server connected to the Internet or cloud-based server that may contain an account database including information regarding an audio system account of a user, audio sources, and other audio playback devices 10 via one or more communications protocols. The network interface 20 may provide either or both of a wireless interface 30 and a wired interface 32. The wireless interface 30 allows the audio playback device 10 to communicate wirelessly with other devices in accordance with a communication protocol such as such as IEEE 802.11b/g. The wired interface 32 provides network interface functions via a wired (e.g., Ethernet) connection.

In some examples, the network interface 20 may also include a network media processor 34 for supporting Apple AirPlay® (a proprietary protocol stack/suite developed by Apple Inc., with headquarters in Cupertino, Calif., that allows wireless streaming of audio, video, and photos, together with related metadata between devices). For example, if a user connects an AirPlay® enabled device, such as an iPhone or iPad device, to a LAN which the audio playback device 10 is in communication with, the user can then stream music to the network connected audio playback device 10 via Apple AirPlay®. The network media processor 34 provides network access (e.g., the Wi-Fi network and/or Ethernet connection can be provided through the network media processor 34) and AirPlay® audio. AirPlay® audio signals are passed to the processor 22, using the I2S protocol (an electrical serial bus interface standard used for connecting digital audio devices), for downstream processing and playback. Notably, the audio playback device 10 can support audio-streaming via AirPlay® and/or DLNA's UPnP protocols, and all integrated within one device.

All other digital audio coming from network packets comes straight from the network media processor 34 through a USB bridge 36 to the processor 22 and runs into the decoders, DSP, and eventually is played back (rendered) via the electro-acoustic transducer(s) 15.

The network interface 11 can also include a Bluetooth low energy (BTLE) system 38 for Bluetooth low energy applications (e.g., for wireless communication with a Bluetooth enabled controller).

Streamed data pass from the network interface 20 to the processor 22. The processor 22 can execute instructions within the audio playback device (e.g., for performing, among other things, digital signal processing, decoding, and equalization functions), including instructions stored in the memory 28. The processor 22 may be implemented as a chipset of chips that include separate and multiple analog and digital processors. The processor 22 may provide, for example, for coordination of other components of the audio playback device 10, such as control of user interfaces, or applications run by the audio playback device 10.

The processor 22 provides a processed digital audio signal to the audio hardware 24 which includes one or more digital-to-analog (D/A) converters for converting the digital audio signal to an analog audio signal. The audio hardware 24 also includes one or more amplifiers which provide amplified analog audio signals to the electroacoustic transducer(s) 15 for playback. In addition, the audio hardware 24 may include circuitry for processing analog input signals to provide digital audio signals for sharing with other devices.

The memory 28 stores information within the audio playback device 10. In this regard, the memory 28 may store account information, such as information regarding the audio station or channel presets. The memory 28 may also provide storage for “tokens” for facilitating single press access to the digital audio sources, for example, Internet radio services. A token, as used herein, is a unique identifier that may be provided by a digital audio source and which allows the digital audio source to recognize the audio playback device 10 as being associated with a user's account with the digital audio source and without requiring the user to enter credentials (e.g., user name, password, etc.) each time the audio playback device 10 attempts to access the digital audio source.

The memory 28 may include, for example, flash memory and/or non-volatile random access memory (NVRAM). In some implementations, instructions (e.g., software) are stored in an information carrier. The instructions, when executed by one or more processing devices (e.g., the processor 22), perform one or more processes, such as those described below for assigning stations, channels, or playlists to the preset indicators 18 of the streaming music player. The instructions can also be stored by one or more storage devices, such as one or more computer- or machine-readable mediums (for example, the memory 28, or memory on the processor). The instructions may include instructions for performing decoding (i.e., the software modules include the audio codecs for decoding the digital audio streams), as well as digital signal processing and equalization. In accordance with some aspects and implementations, the memory 28 includes instructions that when executed by the processor cause the processor to access a cloud-based database including account information associated with the audio playback device 10 including a set of user-defined audio channel presets and to assign the user-defined audio channel presets to the plurality of preset indicators 18.

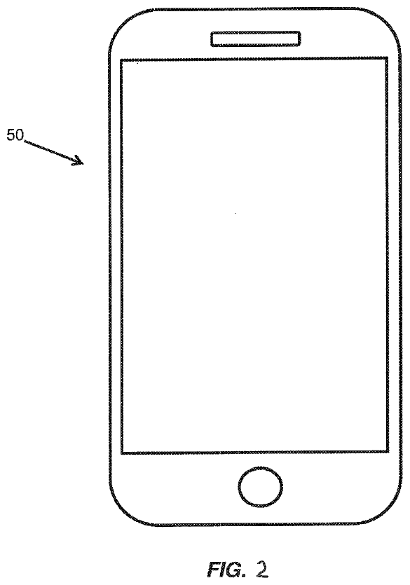

A user may operate the streaming music player by interacting directly with the user input interface 16. Alternatively, a user may operate the streaming music player using a control app installed on a streaming music player controller, for example, a smart phone 50, FIG. 2, or another mobile device such as a tablet. In some implementations, in addition to or as an alternative to assigning content to hardware preset indicators 18 provided on the streaming music player, content may be assigned to “virtual presets” (e.g., represented by software buttons) that are accessible and selectable through the control app installed on the streaming music player controller. Accordingly, discussion herein of assigning content to the preset indicators 18 of the streaming music player applies equally to assigning content to “virtual presets” accessible and selectable through the control app installed on the streaming music player controller.

In some implementations, information regarding how the user programmed each preset of a streaming music player may be stored in an online or cloud-based user account associated with the user or the user's streaming music player. The user may access the information regarding the programming of the different presets stored in the user's account using different streaming music players to assign different or at least one common preset to the different streaming music players.

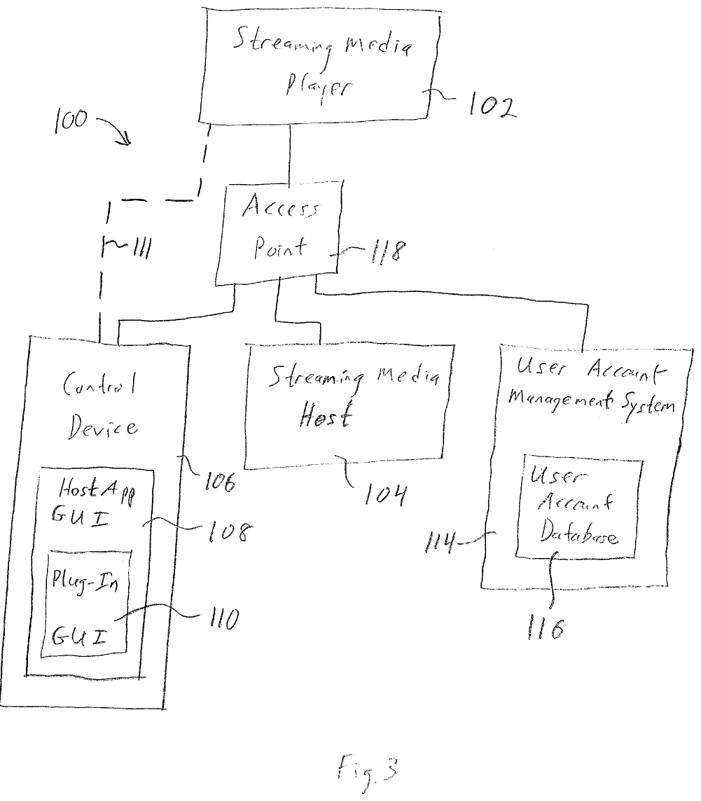

FIG. 3 illustrates an exemplary system 100 that is configured to provide streaming media to, and control of, a streaming media player 102. Media player 102 in one non-limiting example is a Bose Home Speaker 500 available from Bose Corp. of Framingham, Mass., U.S.A. The source or sources of streaming media are represented by streaming media host 104. Streaming media host 104 may be but need not be one or more cloud-based streaming music services, such as those described elsewhere herein. User account management system 114 is typically associated with a cloud-based service provided by the seller of media player 102. User account management system 114 typically comprises a computer (e.g., a server) with software that is configured to cause the computer to store and manage user accounts, and functions to allow registered users to log into their account, browse and access streaming media that is provided to media player 102, and control media player 102. Other functions that are known in the field can be provided for by user account management system 114. User account management systems are further described in U.S. Patent Application Publication 2015/0100623, the entire disclosure of which is incorporated herein by reference for all purposes.

Control device 106 is a computing device that is employed by a user to control media player 102 and browse and select audio sources, such as host 104. Control device 106 may be but need not be a smartphone, tablet, laptop, or other computing device. As depicted, media player 102, host 104, control device 106, and user account management system 114 can all be interconnected via access point 118. Connection between control device 106 and player 102 can also be direct, e.g., via Bluetooth link 111. The connection and operation of streaming media players to streaming media hosts, control devices, and user account management systems are described in more detail in the U.S. Patent Application Publication 2015/0100623 that is incorporated herein by reference. The devices can be connected by wired and/or wireless interconnection, which is well known in the field.

Control device 106 includes a control app for media player 102. The control app typically allows the user to control the media player, access media content, and tag content for later access. Media player control apps are described in more detail in the U.S. Patent Application Publication 2015/0100623 that is incorporated herein by reference. Media player control apps are well known in the field and so are not further described herein. An example of a media player control app that can be used with the Bose Home Speaker 500 and other wireless loudspeakers is the Bose Music app, available from Bose Corp., Framingham, Mass., U.S.A.

Control device 106 also includes an app for media host 104, and GUI 108 for the host app. An example of a media host app is the Spotify® app. Host app GUI 108 allows the user to interact with the media host via the app. Control device 106 also includes a plug-in that is integrated into the host app. The plug-in comprises code that is fully integrated into the host app code. The plug-in is a software program that provides for some or all of the functionality of the media player control app, as is further described below. Control device 106 also includes GUI elements 110 for this plug-in. Plug-in GUI elements 110 are displayed within host app GUI 108, so that the access and functionality to the host app and the plug-in are fully integrated from the point of view of the user. The plug-in may or may not provide its own GUI that is displayed within the host app GUI 108.

The integration of the plug-in into the host app that is needed to accomplish system 100 can in one instance be accomplished by integrating into the code for the host app appropriate code (such as a software development kit (SDK)) for the plug-in. The integrated code includes code needed to establish plug-in GUI elements 110 within or as part of host app GUI 108.

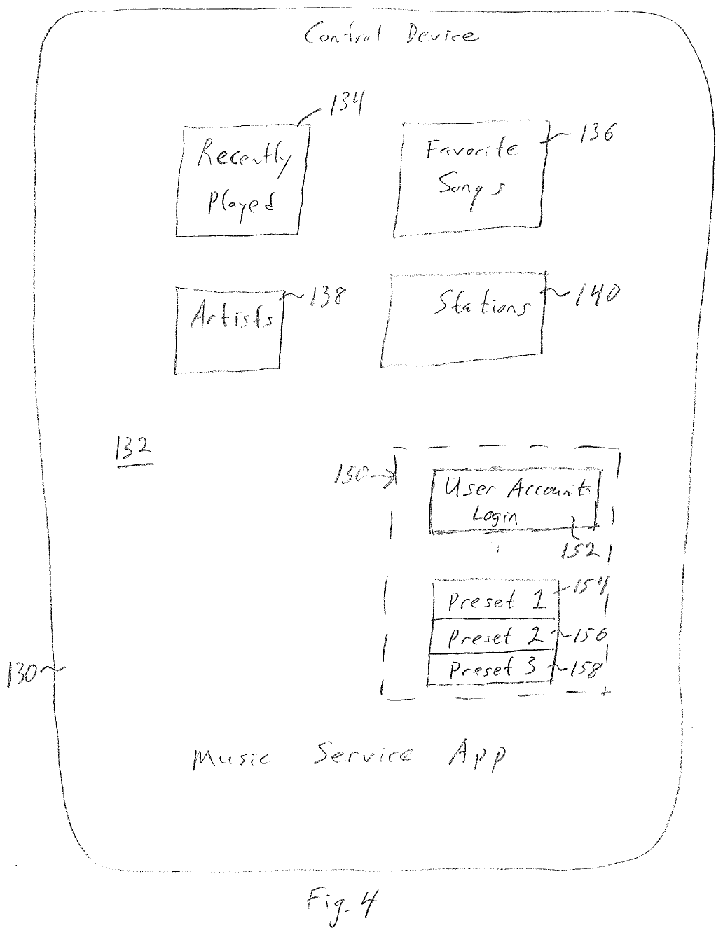

An exemplary GUI 132 for exemplary control device 130 (e.g., a smartphone) is illustrated in FIG. 4, where host app GUI 132 is for an internet-based music service such as Spotify®. Music service host app GUI 132 includes icons or other displays that provide for control of the music service app. Non-limiting examples of control icons include buttons for recently played 134, favorite songs 136, artists 138, and stations 140. “Recently played” are songs that have been recently played using the music service. “Favorite songs” are songs that are most liked or most played using the media service. “Artists” includes all artists for music that has been saved by the user of the music service. “Stations” includes internet radio stations that have been played by or are made available to the user of the music service. These are several non-limiting examples of ways in which music services allow users to access and play their content. Since the music service host app does not itself form a part of the present disclosure, and since music service apps are well known, the music service app, the app GUI, and the music service app GUI features, are not further disclosed herein.

Plug-in GUI 150 that is integrated into GUI 132 in this non-limiting example includes GUI elements such as software button 152 that allows a user to log into the user account management system 114, and buttons 154, 156, and 158 that allow the user to set-up, access and play presets 1-3. There could be any number of presets, from one up. Presets are only one way that streamed media content is tagged so that it can be accessed later (e.g., via the control app or via preset buttons on the media player). Other ways in which content can be tagged are also contemplated and included herein, including for example playlists or other collections of audio, favorites, recents, artists, and stations. There could be fewer or more buttons in GUI elements 150, each button for creating a saved listing of and/or for accessing streamed media content. As indicated by the dashed line encompassing GUI elements 150, there may be no border or other demarcation between GUI elements 150 and GUI 132. A result is that, from the user's point of view, the functions of the plug-in that can be accessed using plug-in GUI elements 150 are an integral part of the music service GUI 132.

A result of this integration of the elements of the plug-in app GUI (including at least one preset button) with the streaming media host GUI is that the user can select host media content (e.g., an internet radio station) or a host media identifier and assign the content or identifier to a media player preset, all from the same GUI. Assigning content to a preset and later accessing the content via the preset is known in the field, for example as disclosed in U.S. Patent Application Publication 2018/0176274, the entire disclosure of which is incorporated herein by reference for all purposes. Later, the user can access this tagged content by pressing a corresponding preset button (a hardware or software button) on a media player, or on the media player control app GUI, or on GUI 150.

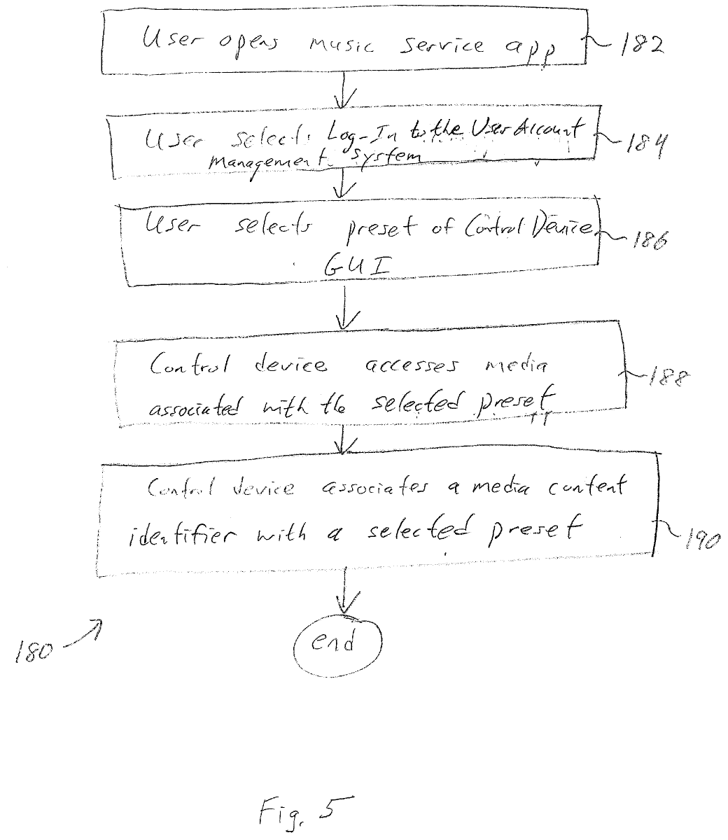

FIG. 5 is a flow chart of an exemplary method 180 for controlling a streaming music player, where the user account management system associated with the music player is account based. It should be understood that in alternative arrangements one or both of the third-party music service and the streaming music player controller need not be account-based. Control of the streaming music player in this non-limiting example includes tagging content within the third-party app and associating the tagged content with the user's streaming player account. In step 182, the user opens a third-party music service app using a control device (e.g., a smartphone). The app may be but need not be an account-based app. The music service app typically includes media identifiers for content that is available from the music provider cloud, or may have already been accessed and cached via the music provider cloud. Non-limiting examples of media identifiers include “Acoustic Hits” and “Recently Played.” When the music service app is opened, the app GUI loads, and it includes plug-in GUI elements as described above and exemplified by GUI elements 150, FIG. 4. The user selects the user account management system login from the GUI, step 184. Once the user is logged into the user account management system (if login is required), the user can select a preset in the part of the control device GUI that carries the plug-in GUI elements, step 186. Preset selection can cause the control device to access and play content that was previously assigned to the selected preset, step 188, as is known in the art. Content can be played directly by the control device, or it can be played by the streaming media player, as is also known in the art. The user can also use the control device to set a preset. This can be done by the user associating music service content with a particular preset. In one non-limiting example, to do this the user tags content within the third-party app so as to associate the content with the user's music player account. In one non-limiting example a preset plug-in allows a user to select and assign music content that is accessed via the third-party app to presets that are associated with the user's music player account. See step 190, where the control device associates a media content identifier with the selected preset that is part of the media player user account.

Accessing media and associating it with a preset in streaming media players is known in the field and so is not fully described herein. In non-limiting examples, content buttons (e.g., media identifiers) can be dragged onto the appropriate preset button or pressed and held; this causes the control device to communicate with the user account management system which then saves in the database for the user's account and in association with the selected preset, pointers to the tagged content. The content can then be accessed and played by selection of the preset.

This method is not limited to establishing presets. Other functionalities that can be accomplished with a media player control app (such as transport controls, loudspeaker controls, and media/product discovery tools, etc.), can be handled in this same manner, where appropriate software components for the particular function(s) are integrated into the code for the streaming media host app via the plug-in. The media player functionalities can then be accessed and used through the host app GUI that includes appropriate GUI elements for the particular functions.

Typically but not necessarily, user account information is part of a cloud-based media player control system that can be accessed via a control device. Once the media player device function(s) such as presets are associated with the user's account as described above, the functions will be associated with and can be used with any media player and any control device that is associated with the user's account.

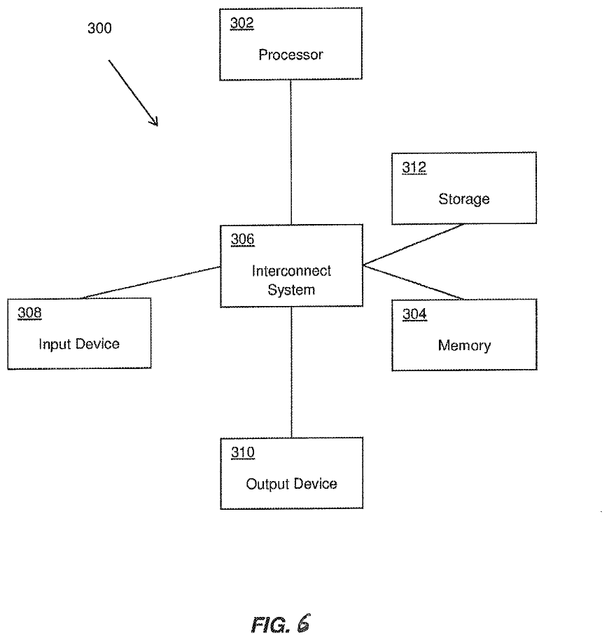

The various computer systems disclosed herein, for example, a computer system hosting the online streaming music account of a user, and the streaming music controller 50 (e.g., a smartphone), or a computer system that is used to program presets for the user, may include specialized software executing in a general-purpose computer system 300 such as that shown in FIG. 6. The computer system 300 may include a processor 302 connected to one or more memory devices 304 and/or storage device 312, such as a disk drive, solid state memory, or other non-transitory recording medium for storing data. Memory 304 is typically used for storing programs and data during operation of the computer system 300. Components of computer system 300 may be coupled by an interconnection mechanism 306, which may include one or more busses (e.g., between components that are integrated within a same machine) and/or a network (e.g., between components that reside on separate discrete machines). The interconnection mechanism 306 enables communications (e.g., data, instructions) to be exchanged between system components of system 300. Computer system 300 also includes one or more input devices 308, for example, a keyboard, mouse, trackball, microphone, and/or touch screen, and one or more output devices 310, for example, a printing device, display screen, and/or speaker.

The computer system may include specially-programmed, special-purpose hardware, for example, an application-specific integrated circuit (ASIC). Aspects and embodiments disclosed herein may be implemented in software, hardware or firmware, or any combination thereof. Further, such methods, acts, systems, system elements and components thereof may be implemented as part of the computer system described above or as an independent component.

Although computer system 300 is shown by way of example as one type of computer system upon which various aspects and embodiments disclosed herein may be practiced, it should be appreciated that aspects and implementations disclosed herein are not limited to being implemented on the computer system as shown in FIG. 6. Various aspects and implementations disclosed herein may be practiced on one or more computers having a different architecture or components than shown in FIG. 6.

Computer system 300 may be a general-purpose computer system that is programmable using a high-level computer programming language. Computer system 300 may be also implemented using specially programmed, special purpose hardware. In computer system 300, processor 302 is typically a commercially available processor such as the well-known Pentium™ or Core™ class processors available from the Intel Corporation. Many other processors are available, including programmable logic controllers. Such a processor usually executes an operating system which may be, for example, the Windows 7, Windows 8, or Windows 10 operating system available from the Microsoft Corporation, the MAC OS System X available from Apple Computer, the Solaris Operating System available from Sun Microsystems, or UNIX available from various sources. Many other operating systems may be used.

One or more portions of the computer system may be distributed across one or more computer systems (not shown) coupled to a communications network. These computer systems also may be general-purpose computer systems. For example, various aspects of this disclosure may be distributed among one or more computer systems configured to provide a service (e.g., servers) to one or more client computers, or to perform an overall task as part of a distributed system. For example, various aspects and embodiments disclosed herein may be performed on a client-server system that includes components distributed among one or more server systems that perform various functions according to various aspects and embodiments disclosed herein. These components may be executable, intermediate (e.g., IL) or interpreted (e.g., Java) code which communicate over a communication network (e.g., the Internet) using a communication protocol (e.g., TCP/IP). In some embodiments one or more components of the computer system 300 may communicate with one or more other components over a wireless network, including, for example, a cellular telephone network.

It should be appreciated that the aspects and implementations disclosed herein are not limited to executing on any particular system or group of systems. Also, it should be appreciated that the aspects and implementations disclosed herein are not limited to any particular distributed architecture, network, or communication protocol. Various aspects and implementations disclosed herein may be programmed using an object-oriented programming language, including but not limited to SmallTalk, Java, C++, Ada, Kotlin, Swift, Objective-C, JavaScript, or C # (C-Sharp). Other object-oriented programming languages may also be used. Alternatively, functional, scripting, and/or logical programming languages may be used, for example, ladder logic. Various aspects and implementations disclosed herein may be implemented in a non-programmed environment (e.g., documents created in HTML, XML or other format that, when viewed in a window of a browser program, render aspects of a graphical-user interface (GUI) or perform other functions). Various aspects and implementations disclosed herein may be implemented as programmed or non-programmed elements, or any combination thereof.

The media player control app operates as a settings and music controller. The app provides an interface that allows the user to access presets, collections, favorites, and recents that are associated with the user's account. The app can be configured to provide audio and display connections to an in-vehicle infotainment system, or to another device such as a Bluetooth speaker or headphones, for example. The app can provide a UI via the head unit in a motor vehicle. The in-vehicle UI can be created by the media control app or some other entity (e.g., software embedded in the vehicle). Also, the UI in the vehicle may or may not be on top of other over-the-top in-vehicle UIs (e.g., Apple CarPlay or Android Auto). These features can allow the user to access the presets, playlists, favorites and recents associated with the user's account.

The user's mobile device running the media player control app may provide a link (e.g., via LTE) that allows the user to browse information associated with the user's account that is displayed on the vehicle GUI, and to access media content via the GUI. The mobile device acts as a link between the cloud-based user account and the vehicle GUI. Communication between the mobile device and the vehicle infotainment system can be by Bluetooth or another wireless protocol, or by a wired communication protocol, for example. Selections made via the vehicle GUI are communicated back to the mobile device. The control app retrieves the requested content from the cloud and transmits it to the vehicle system (e.g., by wired or wireless protocol). As a result, functions associated with the user's media player account can be used in any vehicle with an infotainment system and GUI. An alternative or additional manner by which the user can make selections in the vehicle is by other known interfaces such as radio buttons, non-display touch-sensitive surfaces, knobs, wheels, and the like.

Elements of figures are shown and described as discrete elements in a block diagram. These may be implemented as one or more of analog circuitry or digital circuitry. Alternatively, or additionally, they may be implemented with one or more microprocessors executing software instructions. The software instructions can include digital signal processing instructions. Operations may be performed by analog circuitry or by a microprocessor executing software that performs the equivalent of the analog operation. Signal lines may be implemented as discrete analog or digital signal lines, as a discrete digital signal line with appropriate signal processing that is able to process separate signals, and/or as elements of a wireless communication system.

When processes are represented or implied in the block diagram, the steps may be performed by one element or a plurality of elements. The steps may be performed together or at different times. The elements that perform the activities may be physically the same or proximate one another, or may be physically separate. One element may perform the actions of more than one block. Audio signals may be encoded or not, and may be transmitted in either digital or analog form. Conventional audio signal processing equipment and operations are in some cases omitted from the drawing.

Embodiments of the systems and methods described above comprise computer components and computer-implemented steps that will be apparent to those skilled in the art. For example, it should be understood by one of skill in the art that the computer-implemented steps may be stored as computer-executable instructions on a computer-readable medium such as, for example, floppy disks, hard disks, optical disks, Flash ROMS, nonvolatile ROM, and RAM. Furthermore, it should be understood by one of skill in the art that the computer-executable instructions may be executed on a variety of processors such as, for example, microprocessors, digital signal processors, gate arrays, etc. For ease of exposition, not every step or element of the systems and methods described above is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the disclosure.

A number of implementations have been described. Nevertheless, it will be understood that additional modifications may be made without departing from the scope of the inventive concepts described herein, and, accordingly, other embodiments are within the scope of the following claims.

What is claimed is:

1. A computer-implemented method, comprising:
integrating, within a host application on a control device, a component associated with a user account management system for a streaming media player, wherein the host application is configured to cause the provision of streaming media content and the user account management system is configured to cause the storage of an association of streaming media content with a preset, and wherein the control device comprises a user interface (UI) that comprises a preset access feature and is configured to allow a user to interact with both the host application and the user account management system; and
determining an association, by the user via the control device UI, of streaming media content with a preset access feature, and in response causing the storage of an association of streaming media content with the preset.

2. The method of claim 1, wherein the user account management system is cloud-based and user-account based, and wherein the method further comprises presenting on the UI a login feature for the user's account.

3. The method of claim 1, wherein the component associated with a user account management system for a streaming media player comprises a software development kit (SDK).

4. The method of claim 1, wherein the association of streaming media content that is stored with a preset comprises a media content identifier.

5. The method of claim 1, wherein the preset access feature comprises a software preset button.

6. The method of claim 5, further comprising determining user interaction with the preset button and in response automatically accessing streaming media content.

7. The method of claim 1, wherein the host application is associated with an account based music service that is accessible to a user via a first set of account credentials, and wherein the user account management system is accessible by the user via a second, different, set of account credentials.

8. A system, comprising:
memory; and
one or more processors configured to:
integrate, within a host application on a control device, a component associated with a user account management system for a streaming media player, wherein the host application is configured to cause the provision of streaming media content and the user account management system is configured to cause the storage of an association of streaming media content with a preset, and wherein the control device comprises a user interface (UI) that comprises a preset access feature and is configured to allow a user to interact with both the host application and the user account management system; and
determine an association, by the user via the control device UI, of streaming media content with a preset access feature, and in response cause the storage of an association of streaming media content with the preset.

9. The system of claim 8, wherein the user account management system is cloud-based and user-account based, and wherein the processors are further configured to present on the UI a login feature for the user's account.

10. The system of claim 8, wherein the component associated with a user account management system for a streaming media player comprises a software development kit (SDK).

11. The system of claim 8, wherein the association of streaming media content that is stored with a preset comprises a media content identifier.

12. The system of claim 8, wherein the preset access feature comprises a software preset button.

13. The system of claim 12, wherein the processors are further configured to determine user interaction with the preset button and in response automatically access streaming media content.

14. The system of claim 8, wherein the host application is associated with an account based music service that is accessible to a user via a first set of account credentials, and wherein the user account management system is accessible by the user via a second, different, set of account credentials.

15. One or more non-transitory machine-readable storage devices having encoded thereon computer-readable instructions for causing one or more processors to perform operations comprising:
integrating, within a host application on a control device, a component associated with a user account management system for a streaming media player, wherein the host application is configured to cause the provision of streaming media content and the user account management system is configured to cause the storage of an association of streaming media content with a preset, and wherein the control device comprises a user interface (UI) that comprises a preset access feature and is configured to allow a user to interact with both the host application and the user account management system; and
determining an association, by the user via the control device UI, of streaming media content with a preset access feature, and in response causing the storage of an association of streaming media content with the preset.

16. The one or more non-transitory machine-readable storage devices of claim 15, wherein the user account management system is cloud-based and user-account based, and wherein the operations further comprise presenting on the UI a login feature for the user's account.

17. The one or more non-transitory machine-readable storage devices of claim 15, wherein the component associated with a user account management system for a streaming media player comprises a software development kit (SDK).

18. The one or more non-transitory machine-readable storage devices of claim 15, wherein the association of streaming media content that is stored with a preset comprises a media content identifier.

19. The one or more non-transitory machine-readable storage devices of claim 15, wherein the preset access feature comprises a software preset button.

20. The one or more non-transitory machine-readable storage devices of claim 19, wherein the operations further comprise determining user interaction with the preset button and in response automatically accessing streaming media content.

21. The one or more non-transitory machine-readable storage devices of claim 15, wherein the host application is associated with an account based music service that is accessible to a user via a first set of account credentials, and wherein the user account management system is accessible by the user via a second, different, set of account credentials.
